(19) United States
(12) Patent Application Publication
(10) Pub. No.: US 2026/0128874 A1
(43) Pub. Date: May 7, 2026

(54) Secured Hardware Processing Device

(71) Applicant: Infineon Technologies AG, Neubiberg (DE)

(72) Inventors: Bernd Meyer, München (DE); Florian Mendel, München (DE)

(21) Appl. No.: 19/379,962

(22) Filed: Nov. 5, 2025

(30) Foreign Application Priority Data
Nov. 5, 2024 (DE) 102024210603.8

(51) Int. Cl. H04L 9/08; H04L 9/06

(52) U.S. Cl. CPC H04L 9/0866; H04L 9/0662

(57) ABSTRACT

A hardware processing device is provided comprising (i) several MAC units arranged to be operable in a secure mode conducting at least one addition of a first value and a second value, wherein the first value is represented by a number of shares and the second value is represented by the same number of shares; and at least one multiplication of the first value and the second value based on their shares and a random number; (ii) a multiplexer to switch between the secure mode and a normal mode, wherein the several MAC units are arranged to operate in the normal mode on the first value and the second value instead of the shares of the first value and the shares of the second value.

### TECHNICAL FIELD

The present disclosure is related to secure processing in hardware devices.

### BACKGROUND

An Artificial Intelligence (AI) accelerator, deep learning processor or neural processing unit (NPU) is a class of specialized hardware accelerator or computer system designed to accelerate artificial intelligence and machine learning applications, including artificial neural networks and computer vision. An exemplary AI integrated circuit chip may contain tens of billions of MOSFETs. This sort of dedicated hardware is one particular example of a hardware processing device, also referred to herein as accelerator. Such an accelerator is typically used to speed up the computation of a neural network during training or inference. The accelerator may be subject to attacks, e.g., side channel analysis (SCA). For example, timing analysis (TA) and simple power analysis (SPA) may reveal at least a portion of the topology of the neural network. A differential power analysis (DPA) or differential fault analysis (DFA) may give away weights, bias constants and/or activation functions of the neural network. Moreover, SCA may also be used to extract or modify data processed by the accelerator during training or inference.

Existing approaches provide no or insufficient protection against any attacks based on SCA, TA, SPA, DPA or DFA. Such attacks may also be referred to as side channel attacks.

It is therefore an objective to secure or harden a hardware processing device, in particular said accelerator, against any such attack in an cost-efficient way.

### SUMMARY

This objective may be achieved with the embodiments described herein.

The examples suggested herein may be based on at least one of the following solutions. In particular, combinations of the following features could be utilized in order to reach a desired result.

A hardware processing device is suggested, comprising several MAC units arranged to be operable in a secure mode conducting at least one addition of a first value and a second value, wherein the first value is represented by a number of shares and the second value is represented by the same number of shares;
at least one multiplication of the first value and the second value based on their shares and a random number;
a multiplexer to switch between the secure mode and a normal mode, wherein the several MAC units are arranged to operate in the normal mode on the first value and the second value instead of the shares of the first value and the shares of the second value.

It is noted that “random” or “randomized” used in the context of this application may in particular refer to true randomness, pseudo randomness or even to some deterministic approach that may introduce a sufficient level of entropy.

Toggling between the secure mode and the normal mode introduces a flexibility to only conduct those operations in the secure mode that need to be obfuscated due to potential side channel attacks. This allows adjusting the efficiency of the hardware processing device according to a predefined need or demand.

According to an embodiment,
the number of shares is two;
the first value is x with a length n, represented by the shares x₀ and x₁ such that

$$x = {x}_{0} + {x}_{1} mod {2}^{n} ;$$

the second value is y with the length n, represented by the shares y₀ and y₀ such that

$$y = {y}_{0} + {y}_{1} mod {2}^{n} ;$$

the addition is conducted according to

$$( {x}_{0} , {x}_{1} ) + ( {y}_{0} , {y}_{1} ) = ( {x}_{0} + {y}_{0} mod {2}^{n} , {x}_{1} + {y}_{1} mod {2}^{n} )$$

the multiplication is conducted according to

$$( {x}_{0} , {x}_{1} ) \cdot ( {y}_{0} , {y}_{1} ) = ( r + {x}_{0} \cdot {y}_{0} + {x}_{0} \cdot {y}_{1} mod {2}^{n} , - r + {x}_{1} \cdot {y}_{1} + {x}_{1} \cdot {y}_{0} mod {2}^{n} ) ,$$

with r being the random number.

According to an embodiment, the hardware processing device further comprises a random generator determining the random number.

The random generator mentioned herein may in particular provide a predefined level of entropy.

According to an embodiment, the hardware processing device is a hardware accelerator for neural networks.

### BRIEF DESCRIPTION OF THE FIGURES

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a block diagram visualizing how to implement a multiplication in a secure way.

FIG. 2 shows an exemplary implementation in an accelerator utilizing pipelining.

FIG. 3 shows a diagram of an alternative accelerator without pipelining.

### DETAILED DESCRIPTION

Examples presented herein in particular allow for a randomized masking of data processed by an accelerator, which may be used for quantized neural network inference.

An exemplary accelerator for inference is a DMA-capable (DMA: direct memory access) peripheral for autonomous evaluation of quantized neural networks. It may comprise a single-instruction-multiple-data (SIMD) concept. Several multiply-accumulate (MAC) units may work in parallel on integer data and fixed point or floating point data. Integer data may have a length of 2, 4, 8, 16 or 32 bits and fixed point or floating point data may have a length of 8, 16 or 32 bits.

Examples introduced herein comprise a 2-share additive masking scheme on hardware level. A value x of a length n bits is replaced by two shares (x₀, x₁) of length n bits each such that

$$x = {x}_{0} + {x}_{1} mod {2}^{n} . \qquad ( 1 )$$

Then, a scheme which is homomorphic with addition and multiplication can be applied.

For example, an addition of two values x and y, wherein each of the values is represented by 2 shares, can be conducted component by component as follows:

$$( {x}_{0} , {x}_{1} ) + ( {y}_{0} , {y}_{1} ) = ( {x}_{0} + {y}_{0} mod {2}^{n} , {x}_{1} + {y}_{1} mod {2}^{n} ) \qquad ( 2 )$$

Further, a multiplication of the values x and y, based on their respective shares, corresponds to:

$$( {x}_{0} , {x}_{1} ) \cdot ( {y}_{0} , {y}_{1} ) = ( r + {x}_{0} \cdot {y}_{0} + {x}_{0} \cdot {y}_{1} mod {2}^{n} , - r + {x}_{1} \cdot {y}_{1} + {x}_{1} \cdot {y}_{0} mod {2}^{n} ) \qquad ( 3 )$$

wherein r is a random value of length n bits. Examples suggested herein may efficiently utilize existing hardware, in particular SIMD hardware, adding only small modifications. In an exemplary embodiment, two MAC units can be used together. Multiplication of shares can be conducted in a pipelined manner. A multiplexer can be employed for grouping MAC units and/or for switching between a standard mode or “normal” mode (without utilizing any shares and additive data masking), and a secure mode (masked additions and multiplication of shares as described herein).

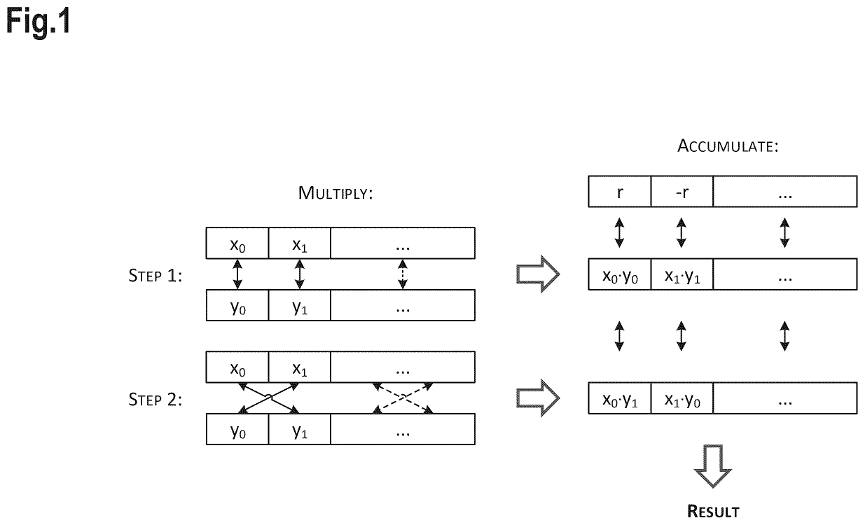

FIG. 1 shows a block diagram visualizing how the multiplication in the secure mode as stated above can be realized.

In a step 1, the multiplications

$${x}_{0} \cdot {y}_{0} , {x}_{1} \cdot {y}_{1}$$

are conducted on the shares of the values x and y, followed by accumulations

$${x}_{0} \cdot {y}_{0} + r , {x}_{1} \cdot {y}_{1} - r .$$

with the random value r.

In a subsequent step 2, multiplications

$${x}_{0} \cdot {y}_{1} , {x}_{1} \cdot {y}_{0}$$

are conducted followed by accumulations leading to the result

$${x}_{0} \cdot {y}_{0} + r + {x}_{0} \cdot {y}_{1} , {x}_{1} \cdot {y}_{1} - r - {x}_{1} \cdot {y}_{0} ,$$

which corresponds to Equation (3) as stated above.

The multiplexer can be used to select the suitable input for the different multiplications conducted in step 1 and step 2. A random source, e.g., a true random number generator or a pseudo-random generator, may be used to generate the random value r to refresh the randomized sharing of the result of the operation.

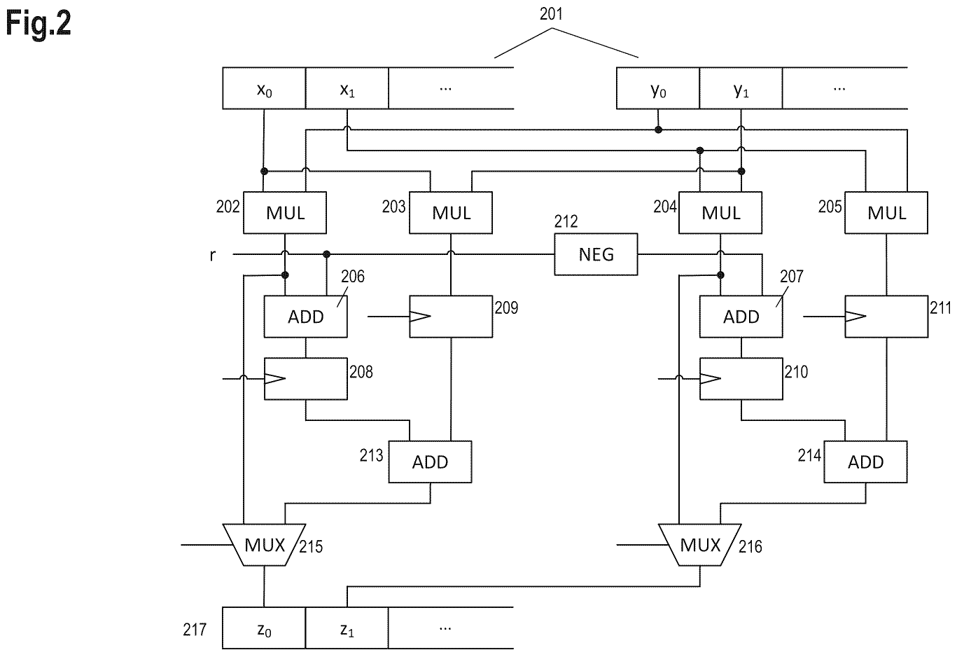

FIG. 2 shows an exemplary implementation of Equation (3) in an accelerator utilizing pipelining.

Shared values (x₀, x₁) instead of the value x and shared values (y₀, y₁) instead of the value y are provided by a memory or register 201. A multiplier 202 multiplies the value x₀ with the value y₀, a multiplier 203 multiplies the value x₀ with the value y₁, a multiplier 204 multiplies the value x₁ with the value y₁ and a multiplier 205 multiplies the value x₁ with the value y₀.

An adder 206 adds the output of the multiplier 202 with the value r, providing a result x₀·y₀+r. An adder 207 adds the output of the multiplier 204 with the negative value r (supplied via a negating processing unit 212), providing a result x₁·y₁−r.

In a subsequent clock cycle (indicated by the flip-flops 208 to 211, which store and delay the partial results for a clock cycle)
an adder 213 adds the output of the adder 206 and the multiplier 203 resulting in x₀·y₀+r+x₀·y₁ and
an adder 214 adds the output of the adder 207 and the multiplier 205 resulting in x₁·y₁−r+x₁·y₀.

A multiplexer 215 and a multiplexer 216 are used to toggle between the secure mode and the normal mode. In the secure mode, the multiplexer 215 connects the output of the adder 213 to a register 217, storing the obfuscated value

$${z}_{0} = {x}_{0} \cdot {y}_{0} + r + {x}_{0} \cdot {y}_{1} .$$

Accordingly—also in secure mode—the multiplexer 216 connects the output of the adder 214 to the register 217, storing the masked value

$${z}_{1} = {x}_{1} \cdot {y}_{1} - r + {x}_{1} \cdot {y}_{0} .$$

In normal mode, however, the output of the multiplier 202 is directly connected to the register 217 without delay by flip-flops storing the result of the multiplication

$${z}_{0} = {x}_{0} \cdot {y}_{0} .$$

Accordingly, in normal mode, the output of the multiplier 204 is connected to the register 217 storing the result of the multiplication

$${z}_{1} = {x}_{1} \cdot {y}_{1} .$$

In normal mode, x₀ and y₀ may represent two independent actual values (not shares). This applies accordingly to the values x₁ and y₁.

Switching between normal mode and secure mode allows for a high flexibility with regard to particular operations that are to be protected most against side channel attacks: For such operations, the secure mode can be used in contrast to less critical operations, which do not require any additive sharing, but can be conducted at a faster pace.

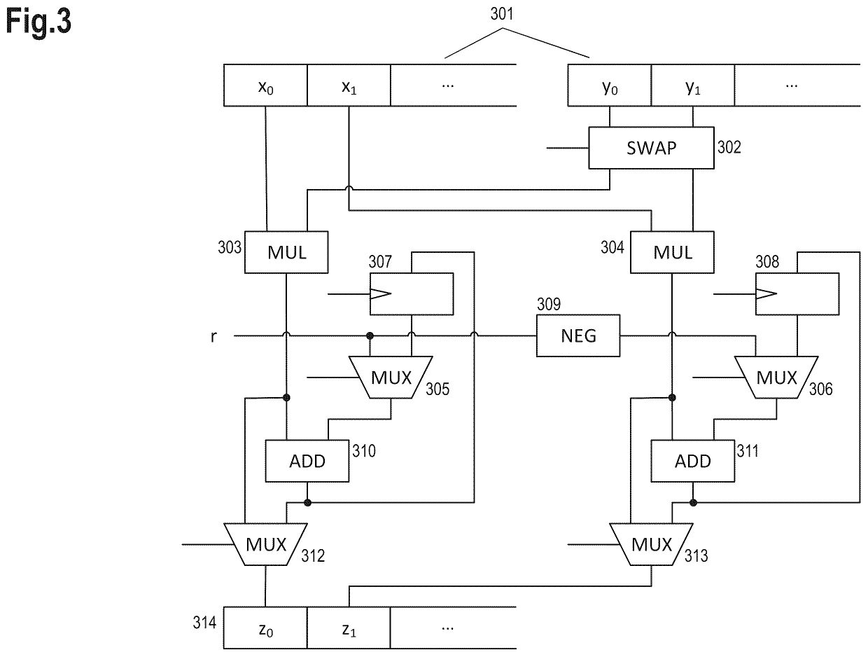

FIG. 3 shows a diagram of an alternative implementation, without pipelining. The overall functionality of this accelerator is similar to the one shown in FIG. 2.

A memory or register 301 supplies the shared values (x₀, x₁) and (y₀, y₁). A module 302 is used to swap between the values y₀, y₁, i.e., providing either the values y₀, y₁ or the values y₁, y₀ at its two outputs.

A multiplier 303 multiplies the value x₀ with the value y₀, wherein the value y₀ is selected via the module 302. An adder 310 then adds the value r, which is selected via a multiplexer 305 to obtain x₀·y₀+r. This value is temporarily stored in a register (indicated by the flip-flop 307). In a next clock cycle, the multiplexer 305 selects the value stored in the register 307 and the multiplier 303 multiplies the value x₀ with the value y₁ (in this subsequent clock cycle this respective other value y₁ is selected by the module 302). Hence, after the second clock cycle, the output at the adder 310 is

$${x}_{0} \cdot {y}_{0} + r + {x}_{0} \cdot {y}_{1} ,$$

which can then be stored as z₀ in a register 314 via a multiplexer 312.

Similarly, a multiplier 304 multiplies the value x₁ with the value y₁, wherein the value y₀ is selected via the module 302. An adder 311 then subtracts the value r (determined via a negating processing unit 309), which is selected via a multiplexer 306 to obtain x₁·y₁−r. This value is temporarily stored in a register (indicated by the flip-flop 308). In a next clock cycle, the multiplexer 306 selects the value stored in the register 308 and the multiplier 304 multiplies the value x₁ with the value y₀ (in this subsequent clock cycle this respective other value y₀ is selected by the module 302). Hence, after the second clock cycle, the output at the adder 311 is

$${x}_{1} \cdot {y}_{1} - r + {x}_{1} \cdot {y}_{0} ,$$

which can then be stored as z₁ in the register 314 via a multiplexer 313.

This scenario refers to the secure mode, wherein the multiplexers 312 and 313 are toggled to store the outputs of the adders 310 and 311, which are based on the shares as described above, in the register 314.

It is noted that the example described above may be supplemented by additional hardware measures to avoid, e.g., Hamming distance leakage in the non-pipelined implementation as dependent data is computed by the same hardware in Step 1 and Step 2. For example, the data in the SIMD register 301 may be swapped in Step 2 and the multiplexers 305 and 306 can be modified to select the equivalent/correct registers 307 and 308 in Step 2. Also, the output values can be swapped such that the results are correct in the SIMD register 314. This can be achieved by changing the inputs to the multiplexers 312 and 313 accordingly.

However, in the normal mode, the multiplexers 312 and 313 can be toggled to their other inputs, which allows storing directly the output of the multiplier 303 as value z₀ and the output of the multiplier 304 as value z₁ without delay by flip-flops. Hence, in the normal mode, there is no multiplication of additively shared data, only a direct multiplication of the input values.

It is noted that in normal mode the values x₀, x₁, y₀ and y₀ are independent values that are subject to the multiplication, not shares. This applies to FIG. 2 similarly.

In view of the detailed examples described above, it will be appreciated that the circuits described herein can be generalized as a hardware processing device that comprises a plurality of multiply-accumulate units (MAC units), configured so as to conduct, in a secure mode, at least one addition of a first value and a second value, wherein the first value is represented by a number of shares and the second value is represented by the same number of shares, and at least one multiplication of the first value and the second value based on their shares and a random number. This hardware processing device further comprises a multiplexer to switch between the secure mode and a normal mode, where the plurality of MAC units are configured so as to, in the normal mode, operate on the first value and the second value instead of the shares of the first value and the shares of the second value.

In some embodiments, e.g., in the specific examples shown in FIGS. 1 and 2, the number of shares is two, the first value is x with a length n, represented by the shares x0 and x1 such that

$$x = {x}_{0} + {x}_{1} mod {2}^{n}$$

and the second value is y with the length n, represented by the shares y0 and y1 such that

$$y = {y}_{0} + {y}_{1} mod {2}^{n} .$$

The addition in these embodiments is conducted according to

$$( {x}_{0} , {x}_{1} ) + ( {y}_{0} , {y}_{1} ) = ( {x}_{0} + {y}_{0} mod {2}^{n} , {x}_{1} + {y}_{1} mod {2}^{n} ) ;$$

and
the multiplication is conducted according to

$$( {x}_{0} , {x}_{1} ) \cdot ( {y}_{0} , {y}_{1} ) = ( r + {x}_{0} \cdot {y}_{0} + {x}_{0} \cdot {y}_{1} mod {2}^{n} , - r + {x}_{1} \cdot {y}_{1} + {x}_{1} \cdot {y}_{0} mod {2}^{n} ) ,$$

with r being the random number.

In some embodiments, the hardware processing device may further comprise a random generator configured to determine the random number. In some embodiments, the hardware processing device is a hardware accelerator for neural networks.

1. A hardware processing device, comprising
a plurality of multiply-accumulate units (MAC units), configured so as to conduct, in a secure mode,
at least one addition of a first value and a second value, wherein the first value is represented by a number of shares and the second value is represented by the same number of shares;
at least one multiplication of the first value and the second value based on their shares and a random number;
a multiplexer to switch between the secure mode and a normal mode, wherein the plurality of MAC units are configured so as to, in the normal mode, operate on the first value and the second value instead of the shares of the first value and the shares of the second value.

2. The hardware processing device of claim 1,
wherein the number of shares is two;
wherein the first value is x with a length n, represented by the shares x₀ and x₁ such that
$$x = {x}_{0} + {x}_{1} mod {2}^{n}$$
wherein the second value is y with the length n, represented by the shares y₀ and y₁ such that
$$y = {y}_{0} + {y}_{1} mod {2}^{n} ;$$
wherein the addition is conducted according to
$$( {x}_{0} , {x}_{1} ) + ( {y}_{0} , {y}_{1} ) = ( {x}_{0} + {y}_{0} mod {2}^{n} , {x}_{1} + {y}_{1} mod {2}^{n} ) ;$$
wherein the multiplication is conducted according to
$$( {x}_{0} , {x}_{1} ) \cdot ( {y}_{0} , {y}_{1} ) = ( r + {x}_{0} \cdot {y}_{0} + {x}_{0} \cdot {y}_{1} mod {2}^{n} , - r + {x}_{1} \cdot {y}_{1} + {x}_{1} \cdot {y}_{0} mod {2}^{n} ) ,$$
with r being the random number.

3. The hardware processing device of claim 1, further comprising a random generator configured to determine the random number.

4. The hardware processing device of claim 1, wherein the hardware processing device is a hardware accelerator for neural networks.
